(19) United States
(12) Patent Application Publication
(10) Pub. No.: US 2017/0076310 A1
(43) Pub. Date: Mar. 16, 2017

(54) SYSTEM AND METHOD TO REALIZE ADVERTISEMENT DESIGNATE PUSHING AND CUSTOMERS CONTACT BASED ON CUSTOMERS' NETWORK BEHAVIOR

(71) Applicants: CHENYU YAN, SHENZHEN (CN); QIAN CHEN, SHANGHAI (CN)

(72) Inventors: CHENYU YAN, SHENZHEN (CN); QIAN CHEN, SHANGHAI (CN)

(21) Appl. No.: 15/017,193

(22) Filed: Feb. 5, 2016

(30) Foreign Application Priority Data
Sep. 16, 2015 (CN) 201510591303.X
Dec. 29, 2015 (CN) 201511019982.X

(51) Int. Cl. G06Q 30/02

(52) U.S. Cl. CPC G06Q 30/0215; G06Q 30/0255; G06Q 30/0236

(57) ABSTRACT

A system and method are provided to realize advertisement designate pushing and customers contact based on customers' network behavior, which includes a data server, advertiser devices and clients, the data server is used to match the customers' network behavior sent by the clients and the advertisement information sent by the advertiser devices and send the contact information of customers who has authorized to designate advertiser devices according to authorization behavior sent by the clients, the advertiser devices are used to designate push advertisement to customers according to the matching result of the data server manually or according to the previously determined smart pushing advertisement strategy, the clients are used to filter and display the advertisement sent by the advertiser devices and receive the customers' network behavior and authorization behavior.

### FIELD OF TECHNOLOGY

The present invention relates to Internet technology area, especially to E-commerce technology area, in particular to a system and method to realize advertisement designate pushing and customers contact based on customers' network behavior.

### DESCRIPTION OF RELATED ARTS

This method aims at solving the problem that the network advertising efficiency of the prior art is not high. The network advertisement of the prior art is delivered based on system's automatic analysis, and there is smaller degree of freedom in delivering for advertisers, which can only depend on system's passive advertisement delivering, and there is no accurate and effective data statistical analysis and feedback mechanism for the advertising efficiency. After the network advertisement is presented to aimed customers, the advertisers cannot get the aimed customers' contact information nor build direct contact with them. For the network advertisement cannot completely answer all the questions of the customers (and the telephone contact from sales can be more complete and comprehensive), the customers may not develop contact with them. If the customers do not develop contact actively with advertisers, the advertising efficiency cannot be transformed into sales behavior, and the advertising efficiency is not realized.

Besides, the existing method of advertisement pushing also cannot satisfy the customers' demand. Especially when the customers do not know their own needs, they are easily steered in the right direction during searching for a professional to provide a solution, which will lead to a lot of waste of money and time for the customers. For example, the existing attached display advertisement only pushes advertisement to customers strongly based on simple analysis of customers' property while ignores the specific true demand of the customers. It gives too much ineffective information to customers and the information that the customers truly need is overwhelmed by the ineffective information. So the advertisement effect is quite small. The existing advertisement pushing through search engine has certain pertinence with respect to the customers demand. But when the customers cannot confirm their true demand clearly, they must search information again and again on the search engine and connect many times with a related professional, thereby wasting considerable time.

### SUMMARY OF THE INVENTION

The present invention aims to overcome the above drawbacks of the prior arts, and provide a system and method to realize advertisement designate pushing and customers contact based on customers' network behavior which can realize a larger degree of freedom in advertisement delivering, a greater advertising efficiency and a wider application range.

To achieve the above-mentioned objectives, the system and method to realize advertisement designate pushing and customers contact based on customers' network behavior of the present invention have the following aspects:

The system to realize advertisement designate pushing and customers contact based on customers' network behavior, is characterized in that, the system includes a data server, advertiser devices and clients, the data server is used to match the customers' network behavior sent by the clients and the advertisement information sent by the advertiser devices and send the contact information of customers who have authorized to designate advertiser devices according to authorization behavior sent by clients, the advertiser devices are used to designate push advertisements manually or according to smart pushing advertisement strategy previously determined to the clients according to the matching result of the data server, the clients are used to filter and display the advertisements sent by the advertiser devices and receive the customers' network behavior and authorization behavior.

Preferably, the advertiser devices are also used to send credits value expected to get to the clients, send actual credits to the clients according to the communication situation between the advertisers and customers and calculate credits and send rewards to the clients, the actual credits' value is a certain percentage of the credits value expected to get; the clients are also used to display the credits value expected to be obtained, corresponding to the advertisement and get the credits of the advertisement corresponding to the authorization behavior.

The invention also relates to a method to realize advertisement designate pushing and customers contact based on customers' network behavior based on the system, characterized in that, the method comprises:

(1) The data server matches the customers' network behavior sent by the clients and the advertisement information sent by the advertiser devices;
(2) The advertiser devices designate push advertisements manually or according to smart pushing advertisement strategy previously determined to the clients;
(3) The clients filter and display the advertisements sent by the advertiser devices;
(4) The customers filter the advertisement that is useful for themselves and authorize, then send the customers' authorization behavior to the data server through the clients;
(5) The data server sends the contact information of the customers who have authorized to designate advertiser devices;
(6) The advertisers communicate with the customers according to the customers' contact information who have authorized.

Preferably, between the steps (2) and (3), there is the following step:

(2-A) The advertiser devices send credits value expected to get to the clients;

between the steps (3) and (4), there is the following step:

(3-A) The clients display the credits value expected to be obtained;

after the step (6), there is further the following step:

(7) The advertiser devices send actual credits to the corresponding clients.

More preferably, the invention is characterized in that, between the step (6) and (7), there is the following step:

(6-A) The advertisers determine the credits value that the customers can actually obtain according to the communication situation with the customers, the actual credits value is a certain percentage of the credits value expected to be obtained.

More preferably, if the advertisers think that the customers have a larger development potential than expectation after communication with the customers, the ratio between the actual credits value and the credits value expected to be obtained is larger than 1; if the advertisers think that the customers have a smaller development potential than expectation after communication with the customers, the ratio between the actual credits value and the credits value expected to be obtained is smaller than 1.

More preferably, the invention is characterized in that, after the step (7), there is the following step:

(8) The advertiser devices calculate the credits and send rewards to the clients.

Preferably, the data server mating the customers' network behavior sent by the clients and the advertisement information sent by the advertiser devices, comprises:

(1-1-A) The data server stores the customers' contact information, receives the advertisement information sent by the advertiser devices or the data server collects and stores the advertisement information according to the advertiser devices' setting;

(1-2-A) The data server receives customers' network behavior through the clients;

(1-3-A) The data server makes an intelligent match between the customers' network behavior and the advertisement information and calculates the matching result of the customers' network behavior and the advertisement information.

Preferably, the data server mating the customers' network behavior sent by the clients and the advertisement information sent by the advertiser devices, comprises:

(1-1-B) The data server receives the advertisement information sent by the advertiser devices or the data server collects and stores the advertisement information according to the advertiser devices' setting;

(1-2-B) The data server receives customers' network behavior through the clients;

(1-3-B) The data server makes an intelligent match between the customers' network behavior and the advertisement information and calculates the matching result of the customers' network behavior and the advertisement information;

the sending the customers' authorization behavior to the data server through the clients, is specifically as follows:

send the customers' authorization behavior and the customers' contact information to the data server through the clients,

Preferably, the previously determined formulate smart pushing advertisement strategy includes clients' locations, customers' history and customer property selection strategy

Preferably, the clients filtering and displaying the advertisements sent by the advertiser devices, includes the following steps:

(3-1) The clients filter the advertisements sent by the advertiser devices according to advertisement filtering strategy previously determined by the customers;

(3-2) The clients display the advertisements after filtering.

More preferably, the advertisement filtering strategy includes advertiser devices' locations, advertisements receiving history and product property selection strategy.

With the utilization of the system and method to realize advertisement designate pushing and customers contact based on customers' network behavior of the invention, there are the following beneficial effects:

(1) The advertisers can have larger degree of freedom in advertisement delivering by means of mating the customers network behavior and the advertisement information by data server and advertisement designate pushing according to the matching result by the advertisers, the advertisement is more accurately delivered;
(2) The advertising conversion rate is greater by means of getting the customers' contact information through data server after the customers have authorized to designate advertisers and establishing face-to-face direct contacts with customers;
(3) With the wide application of smart phone, more and more people have been used to surf the net with phones, but for the reason that the screen area of phones are limited, the original net advertisement display method has been not fit in this (like the ranking advertisement display on the right side of search engine), and it's bad experience for the customers that there is too much advertisement and normal content mixed on the phone screen, while the problem won't be exist by pushing advertisement applying the method of this invention;
(4) The credits will only be sent to clients after the advertisers have communicated with the customers, and the paying credits are corresponding percentage of the credits promised before according to the advertisers' own judgments, so as to prevent fraudulent behavior of some customers searching for stuff they don't need to obtain the credit rewards, the credit rewards will be more relativity, the application range is wider.

### BRIEF DESCRIPTION OF THE DRAWINGS

FIG. 1 is the flow diagram of one embodiment of the method to realize advertisement designate pushing and customers contact based on customers' network behavior of the invention.

### DETAILED DESCRIPTION OF THE PREFERRED EMBODIMENT

In order to describe the technical content of the present invention more clearly, now describe it further combining specific embodiments.

The following content describes one specific embodiment of the system and method to realize advertisement designate pushing and customers contact based on customers' network behavior of the invention. Wherein the system to realize advertisement designate pushing and customers contact based on customers' network behavior includes a data server used to process and transmit intermediate information, clients used to receive and send customers' various information and advertiser devices used to receive and send advertisers' various information. The clients can be devices such as personal computer, tablet PC or cell phone and so on which are used by customers in normal times.

### Embodiment 1

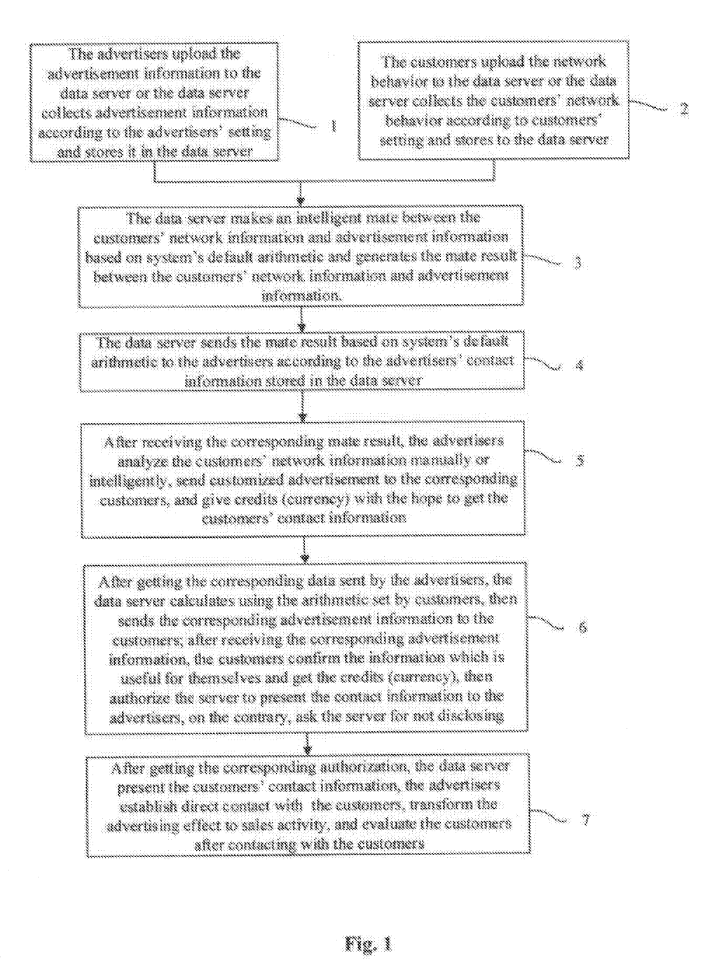

As shown in FIG. 1, the method to realize advertisement designate pushing and customers contact based on customers' network behavior of the invention, includes the following steps:

(1) The data server gets advertisement information from advertisers, the server classifies and arranges it and generates a document based on the advertisement's context and saves it,

Wherein the data server getting advertisement information from advertisers, it can be the advertisers upload the advertisement information to the data server or the data server collects advertisement information according to the advertisers' setting and stores it in the data server.

(2) Use the customers' network behavior on the clients to generate data information, upload the information to the data server according to the customers' setting, generate a document and store.

(3) The data server makes an intelligent match between the customers' network behavior and advertisement information based on system's default algorithm and generates the matching result.

(4) The data server sends the matching result to the advertisers according to the advertisers' contact information in the matching result.

(5) The advertisers screen manually or using system's auto screen function, then designate push advertisement attached with credits values that the customers expected to be obtained to customers.

Wherein, the network behavior can be the input information on the clients by the customers, or the click check behavior or browsing history during browsing websites by the customers, for example, a client input PLC for searching, then click into the website of a certain brand PLC, the browsing history of the customer recorded by the search engine can be a basis for the advertisers to push advertisement. In the same way, the customers' network behavior can be other types behavior of the interaction between the customers and network information.

After receiving the matching result, the advertisers can send advertisement manually or using an algorithm set by themselves, the setting algorithm can be set depending on various properties such as the customers location, the customers' history and the customers' various personal property (occupation, hobby and gender) and so on, the manually pushing advertisement is more flexible. For example, only sending the advertisement once if it is judged to be low value customer, while sending the advertisement several times to high value customer to get deal-making opportunity. For example: the advertiser is the agent of A brand PLC, if two customers input two kinds of network behavior separately: how is B brand PLC, and how to use B brand PLC. In common technology, system will generally deliver advertisements to the two customers automatically. However, manual selection will exclude the network behavior of how to use B brand PLC, for the customer has already bought B brand PLC, he/she just doesn't know how to use it, so the customer basically belongs to low value customer. While the customer who inputs the other information belongs to high value customer, for he/she is still in selection process. But the distinguish act cannot be realized by system intelligence. Here, the invention can realize that the advertisers designate push advertisement manually or push advertisement according to intelligent setting strategy, it can reduce invalid clicks and repeat click effectively.

(6) After receiving the corresponding advertisement information, the customers select advertisement information which is useful to themselves and confirm, check the credits value that the customers expected to obtain, and authorize the server to present their contact information to the advertisers.

The customers can set strategy during receiving, that is, using product properties such as the location of the advertisers, history (like this advertisement won't be received again if it has been received before), price range, producing place and so on as strategy management to filter the advertisement information, screen high-quality information and prevent from harass of spam.

The credits of the invention have three functions: 1. adding the click interest of customers, 2. making it easy for the system to gather advertising fees. 3. preventing from spamming from advertisers. Before the customers expose the contact information, there is no need for the advertisers to pay any fees. Only when the advertisers get the contact information and have communicated with the clients, they need to pay related fees. In this way the advertising fees are used to the greatest extent, the service efficiency is increased, and the advertising activity will be transformed to sales activity more quickly.

(7) After getting the contact information of the customers, the advertisers can contact with the customers directly and recommend product in greater details;

(8) The advertisers judge the development potential of commercial cooperation, and further determine the value that the customers will actually get, then send the credits to the clients of the customers through the advertiser devices.

In a real world application, once the customers want to obtain the credit rewards, there may be certain fraudulent behavior that is, searching for some stuff that they do not need to obtain the credit rewards. The coping method of the invention is: only pay the credits to the clients after the advertisers have communicated with the clients (certainly when the advertisers forget to pay, then the credits will be paid automatically in default time), and the credits will be certain percentage of the credits promised before (the minimize percentage may be 10%, for the advertisers don't want to anger any customers that may have corresponding needs, the percentage may be even higher than 100% to increase the deal-making opportunity), and this is an important strategy composition for the system to support the advertisers to send advertisement.

When the customers cannot confirm their true demand clearly, the method of this invention can well solve the technical problem that the customers cannot get targeted advertisement information quickly and effectively in the existing technology. The customers cannot be clear about their true demand as the related demand is in their non-professional area, which leads to the fact that they cannot describe their true demand perfectly, and the search will have a certain blindness. As to the advertiser, as they are the professional in their products' area, they can get the probable demand of customers based on analysis of key words and website screen records and judge if they can satisfy the customers' demand.

The invention changed the mode that the advertisers can only wait passively for the customers' contacting, and establish a two-way communication relationship with the customers through three-way match:

First match: the customers submit questions based on their demand to the server, the server gets a rough matching result between the customers' network behavior and advertisement information of advertisers and sends the customers' network behavior to the advertisers satisfying the matching result;

Second match: the advertisers judge if they can satisfy the customers' basic demand as they are the professional in the area and send the advertisement information to customers when they think they can satisfy the demand;

Third match: the customers receive the advertisement information from the advertisers and judge based on their own condition (factors such as price, position and so on) and select the advertisement information satisfying their condition and allow the advertisers to get their contact information to further communication.

By the work mode of the above three match, the customers can find better solution providers from many providers with less time and money cost, and the providers can find high quality customers with greater development potential and support service for customers more directly.

### Embodiment 2

It can be realized that using the method to realize advertisement designate pushing and customers contact based on customers' network behavior of the invention to bid based on Internet, which comprises the following steps:

1. The data service gets service abilities of suppliers according to the suppliers' setting, classify and arrange them to generate documents and then store them on the data service
2. The tenderees submit documents of inviting bidding to the data service, wherein their own demands and requirements to suppliers are described.
3. The data service calculates the documents of inviting bidding and the service abilities of suppliers based on presupposed algorithm, and gets corresponding matching results;
4. The data service sends the matching results to the suppliers according to the contact information reserved by the suppliers.
5. After the suppliers have read the corresponding documents of inviting bidding, they write bidding documents based on their own service ability and send it to the tenderees attached with a certain credit value.
6. After the tenderees receive the biding documents of the suppliers, they confirm to corresponding biding documents according to their own actual situation, and authorize the data service to send their contact information to the corresponding suppliers.
7. After the suppliers get the contact information of the tenderees, they contact with the tenderees directly and make deep business cooperation, and send the additional credits after that according to communication situation.

With the utilization of the system and method to realize advertisement designate pushing and customers contact based on customers' network behavior of the invention, there are the following beneficial effects:

(1) The advertisers can have a larger degree of freedom in advertisement delivering by means of mating the customers' network behavior and the advertisement information by data server and advertisement designate pushing according to the matching result by the advertisers, the advertisement is more accurately delivered;
(2) The advertising conversion rate is larger by means of getting the customers' contact information through data server after the customers have authorized to designate advertisers and establishing face-to-face direct contacts with customers:
(3) With the wide application of smart phone, more and more people have been used to surf the net with phones, but for the reason that the screen area of phones are limited, the original net advertisement display method has been not fit in this (like the ranking advertisement display on the right side of search engine), and it's bad experience for the customers that there is too much advertisement and normal content mixed on the phone screen, while the problem won't be exist by pushing advertisement applying the method of this invention;
(4) The credits will only be sent to clients after the advertisers have communicated with the customers, and the paying credits are corresponding percentage of the credits promised before according to the advertisers' own judgments, so as to prevent fraudulent behavior of some customers searching for stuff they don't need to get the credit rewards, the credit rewards will be more relativity, the application range is wider.

In this specification, the present invention has been described with reference to the specific embodiments. However, obviously modifications and variations still can be made without departing from the spirit and range of the invention. Accordingly, the specification and drawings are to be regarded as illustrative rather than restrictive.

We claim:

1. A system to realize advertisement designate pushing and customers contact based on customers' network behavior, characterized in that, the system includes a data server, advertiser devices and clients, the data server is used to match the customers' network behavior sent by the clients and the advertisement information sent by the advertiser devices and send the contact information of customers who have authorized to designate advertiser devices according to authorization behavior sent by clients, the advertiser devices are used to designate push advertisements manually or according to smart pushing advertisement strategy previously determined to the clients according to the matching result of the data server, the clients are used to filter and display the advertisements sent by the advertiser devices and receive the customers' network behavior and authorization behavior,

2. The system to realize advertisement designate pushing and customers contact based on customers' network behavior according to claim 1, characterized in that, the advertiser devices are also used to send credits value expected to get to he clients, send actual credits to the clients according to the communication situation between the advertisers and customers and calculate credits and send rewards to the clients, the actual credits' value is a certain percentage of the credits value expected to get; the clients are also used to display the credits value expected to get corresponding to the advertisement and get the credits of the advertisement corresponding to the authorization behavior.

3. A method to realize advertisement designate pushing and customers contact based on customers' network behavior based on the system of claim 1, characterized in that, the method comprises:
(1) The data server matches the customers' network behavior sent by the clients and the advertisement information sent by the advertiser devices;
(2) The advertiser devices designate push advertisements manually or according to smart pushing advertisement strategy previously determined to the clients;
(3) The clients filter and display the advertisements sent by the advertiser devices;
(4) The customers filter the advertisement that is useful for themselves and authorize, then send the customers' authorization behavior to the data server through the clients;
(5) The data server sends the contact information of the customers who have authorized to designate advertiser devices;
(6) The advertisers communicate with the customers according to the customers' contact information who have authorized.

4. The method to realize advertisement designate pushing and customers contact based on customers' network behavior according to claim 3, characterized in that, between the steps (2) and (3), there is the following step:
(2-A) The advertiser devices send credits value expected to get to the clients;
between the steps (3) and (4), there is the following step:
(3-A) The clients display the credits value expected to get;
after the step (6), there is further the following step:
(7) The advertiser devices send actual credits to the corresponding clients.

5. The method to realize advertisement designate pushing and customers contact based on customers' network behavior according to claim 4, characterized in that, between the step (6) and (7), there is the following step:
(6-A) The advertisers determine the credits value that the customers can actually get according to the communication situation with the customers, the actual credits value is a certain percentage of the credits value expected to get.

6. The method to realize advertisement designate pushing and customers contact based on customers' network behavior according to claim 5, characterized in that, if the advertisers think that the customers have a larger development potential than expectation after communication with the customers, the ratio between the actual credits value and the credits value expected to get is greater than 1; if the advertisers think that the customers have a smaller development potential than expectation after communication with the customers, the ratio between the actual credits value and the credits value expected to get is smaller than 1.

7. The method to realize advertisement designate pushing and customers contact based on customers' network behavior according to claim 4, characterized in that, after the step (7), there is the following step:
(8) The advertiser devices calculate the credits and send rewards to the clients.

8. The method to realize advertisement designate pushing and customers contact based on customers' network behavior according to claim 3, characterized in that, the data server mating the customers' network behavior sent by the clients and the advertisement information sent by the advertiser devices, comprises:
(1-1-A) The data server stores the customers' contact information, receives the advertisement information sent by the advertiser devices or the data server collects and stores the advertisement information according to the advertiser devices' setting;
(1-2-A) The data server receives customers' network behavior through the clients;
(1-3-A) The data server makes an intelligent match between the customers' network behavior and the advertisement information and calculates the matching result of the customers' network behavior and the advertisement information.

9. The method to realize advertisement designate pushing and customers contact based on customers' network behavior according to claim 3, characterized in that, the data server mating the customers' network behavior sent by the clients and the advertisement information sent by the advertiser devices, comprises:
(1-1-B) The data server receives the advertisement information sent by the advertiser devices or the data server collects and stores the advertisement information according to the advertiser devices' setting;
(1-2-B) The data server receives customers' network behavior through the clients;
(1-3-B) The data server makes an intelligent match between the customers' network behavior and the advertisement information and calculates the matching result of the customers' network behavior and the advertisement information;
the sending the customers authorization behavior to the data server through the clients, is specifically as follows:
send the customers' authorization behavior and the customers' contact information to the data server through the clients.

10. The method to realize advertisement designate pushing and customers contact based on customers' network behavior according to claim 3, characterized in that, the previously determined formulate smart pushing advertisement strategy includes clients' locations, customers' history and customer property selection strategy.

11. The method to realize advertisement designate pushing and customers contact based on customers' network behavior according to claim 3, characterized in that, the clients filtering and displaying the advertisements sent by the advertiser devices, includes the following steps of:
(3-1) The clients filter the advertisements sent by the advertiser devices according to advertisement filtering strategy previously determined by the customers;
(3-2) The clients display the advertisements after filtering.

12. The method to realize advertisement designate pushing and customers contact based on customers network behavior according to claim 11, characterized in that, the advertisement filtering strategy includes advertiser devices' locations, advertisements receiving history and product property selection strategy,
